(19) United States
(12) Patent Application Publication
(10) Pub. No.: US 2009/0038016 A1
(43) Pub. Date: Feb. 5, 2009

(54) Detecting And Reacting To Protected Content Material In A Display Or Video Drive Unit

(75) Inventor: Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,477

(22) PCT Filed: Oct. 5, 2005
(86) PCT No.: PCT/IB2005/053280

§ 371 Date: Apr. 2, 2007

Related U.S. Application Data
(60) Provisional application No. 60/616,674, filed on Oct. 7, 2004.

(51) Int. Cl. G06F 21/00

(52) U.S. Cl. 726/27

(57) ABSTRACT

A system and method to protect content material enforce copy protection by establishing a secure link (130-230) between two components (100, 200) that process the protected content material in different forms. This secure link (130-230) is used to communicate security information derived at a first component material from a source (101) to a second component (200) that derives corresponding security information from the material in a transformed form. If the security information from both components is not consistent, the second component (200) prevents subsequent rendering of the content material.

This invention relates to the field of consumer electronics, and in particular to a security system for enforcing copyright protection.

To prevent or minimize the unauthorized distribution of copy-protected material, the providers of authorized copies of the material commonly mark the material with a watermark, or other marking that identifies the material as being copy-protected. Vendors of playback and recording devices have generally agreed to provide “compliant” devices that are designed to enforce copy and playback protection when such copy-protected markings are detected.

Various schemes have been proposed for marking content material to facilitate reliable and effective enforcement of copy and playback protection. U.S. Pat. No. 6,314,518, “SYSTEM FOR TRANSFERRING CONTENT INFORMATION AND SUPPLEMENTAL INFORMATION RELATING THERETO”, issued 6 Nov. 2001 to Johann P. M. G. Linnartz, for example, presents a technique for the protection of copyright material via the use of a watermark “ticket” that controls the number of times the protected material may be rendered, and is incorporated by reference herein. Copending U.S. patent application “PROTECTING CONTENT FROM ILLICIT REPRODUCTION BY PROOF OF EXISTENCE OF A COMPLETE DATA SET VIA SELF-REFERENCING SECTIONS”, U.S. Ser. No. 09/536,944, filed 28 Mar. 2000 for Antonius A. M. Staring, Michael A. Epstein, and Martin Rosner, Attorney Docket US000040, incorporated by reference herein, addresses the illicit distribution of select content material using counterfeit marks by inserting self-referential marks that are based on the content of the material. If the marks that are read from the material do not correspond to the content of the material being provided to a compliant playback or recording device, the device terminates the rendering of the material. International Patent Application PCT/US00/15671 “METHOD AND SYSTEMS FOR PROTECTING DATA USING DIGITAL SIGNATURE AND WATERMARK”, published as WO 00/75925 on 14 Dec. 2000, and incorporated by reference herein, teaches a method and system that watermarks each segment of a disk based on a hash of the contents of a prior segment of the disk. If the contents are modified, via for example, a compression for transmission via the Internet, the watermarks will no longer correspond to a hash of the modified content. U.S. Pat. No. 5,905,800, “METHOD AND SYSTEM FOR DIGITAL WATERMARKING”, issued 18 May 1999, incorporated by reference herein, teaches a watermark that contains a serial number associated with the disk that contains the authorized copy. If the serial number of the media containing the material does not match the serial number in the watermark, a compliant device ceases the playback or copying of the material. U.S. Published Patent Application 2002/0144114, “COPY PROTECTION USING MULTIPLE SECURITY LEVELS ON A PROGRAMMABLE CD-ROM”, published 3 Oct. 2002, incorporated by reference herein, teaches a copy protection scheme that uses multiple security levels, and presents a comprehensive overview of commonly used techniques for copy protection on recordable media.

Content material undergoes several transformations as it progresses from recorded form to renderable form. For example, a movie may be recorded on a DVD disk as digital data arranged by track and sector; a disk reader may convert this information into differential digital video frames (e.g. I, P, and B formatted frames in an MPEG encoding); a video processor may convert this information into a sequence of complete video frames; and a display driver may convert the frames into analog voltages to drive a CRT or an LCD. To provide maximum protection, the mark that is placed on content material is preferably placed on the material so that it is detectable at the latter stages of processing. That is, for example, the mark is preferably not placed on the material so that it is detectable at the DVD track/sector level, because the protection can be avoided by making copies from the differential digital video frame level. Conversely, the information that is used to authenticate the mark, such as the aforementioned serial number, self-referential data, and so on, is preferably based on the material as it is stored on the distribution media, so that a verification of the authenticity of the copy on the media can be verified. That is, for example, a mark on the video image that is based on the content of the video image provides little or no information regarding the media used to convey this image. On the other hand, a mark that is based on a serial number of the media, or an identification of the data set from which the image was derived, can be used to verify that the proper media or data set is being used to provide the current image.

In a conventional self-contained rendering device, such as a portable DVD player with integral display, all or most of the components that are used to transform the information from its stored form to its renderable form are contained within the device. In such a device, verifying that a mark that appears on a latter transformation of the information corresponds to authentication information that is available at the source of the information is a straightforward and relatively secure task. In modular systems, on the other hand, the component that renders the information may be remote from the device that reads the information from the source media. Similarly, in a computer system, the video processing card that provides images to a display screen is substantially independent of the disk drive that accesses the source media.

It is an object of this invention to provide a method and system that facilitates the authentication of a protection mark on content material when the authentication information and the protection mark are derived at different components. It is a further object of this invention to provide a secure means of communicating the authentication information between the different components.

These objects and others are achieved by a system and method that enforce copy protection by establishing a secure link between two components that process protected content material in different forms. This secure link is used to communicate security information derived at a first component that receives the material from a source to a second component that derives corresponding security information from the material in a transformed form. If the security information from both components is not consistent, the second component prevents subsequent rendering of the content material.

The invention is explained in further detail, and by way of example, with reference to the accompanying drawings wherein:

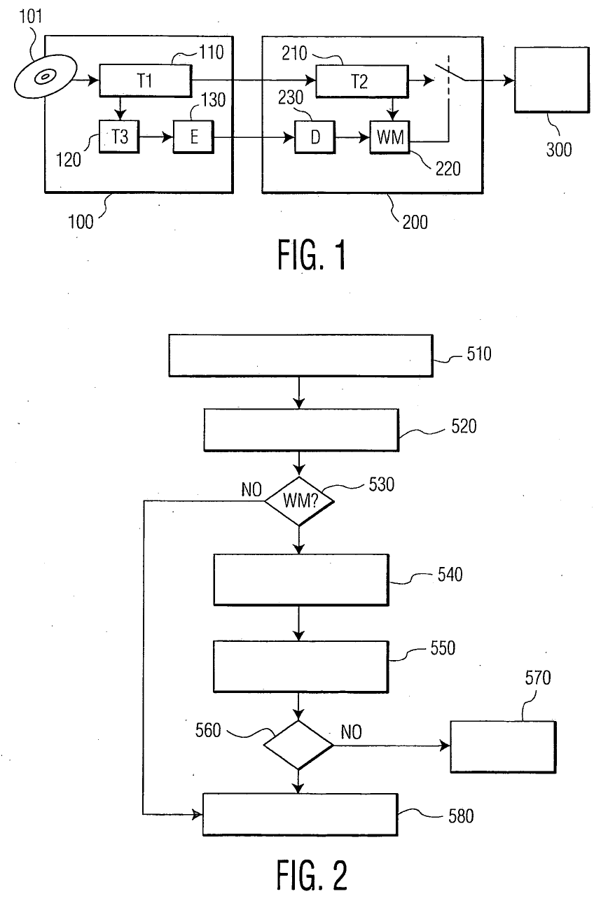

FIG. 1 illustrates an example block diagram of a copy protection system in accordance with this invention.

FIG. 2 illustrates an example flow diagram of a copy protection system in accordance with this invention.

Throughout the drawings, the same reference numeral refers to the same element, or an element that performs substantially the same function. The drawings are included for illustrative purposes and are not intended to limit the scope of the invention.

FIG. 1 illustrates an example block diagram of a copy protection system in accordance with this invention. A first component 100 receives content material from a source 101, such as a recorded media, a communications device, a network interface, and so on. For ease of reference, the invention is presented hereinafter using the paradigm of a recorded media, such as a DVD that contains video, and the component 100 is a DVD disk drive. One or more modules 110 transform the content material from the source into a form that is suitable for processing by a subsequent component 200. For the purposes of this invention, the term transform includes any modification of the data, and may include multiple stages of modifications. Using the video-DVD paradigm, the module 110 includes, for example, an optical reader that reads the data from tracks and sectors of the disk, corrects errors, extracts data from packets, etc., to form I, P, and B frames of digital data that are suitable for processing by a video rendering device.

The second component 200 receives the transformed content material and performs a second transformation before providing the information to a rendering device 300. Again using the video paradigm, the second component may be a video card that includes a module 210 that receives the I, P, and B frames of digital data, creates full sequential frames, and provides these frames to a display device 300.

In accordance with this invention, the second component 200 is configured to extract security information from the transformed content material. The security information is typically in the form of a marking of the transformed content material, such as a watermark that is embedded in the material.

In a typical watermarking system, the watermark information, such as an identifier of the disk, a hash value of a section of the disk, a copyright ticket, and so on, is modulated to produce an encoding that appears as noise at the baseband of the content material. This noise-like signal is added to the content material so that it is virtually undetectable; for example, by selectively inverting the least significant bit of select bytes in the stream of data forming the content material. In some watermarking systems, the watermark is selectively embedded in “busy” portions of the content so as to be less noticeable. For example, in a video stream, the watermark may be embedded in portions of a frame that include trees, draperies, etc.; in an audio stream, the watermark may be embedded in portions of a song that includes a variety of instruments or voices.

As mentioned above, the watermark is preferable added to the content material so that it can be detected as close as possible to its rendered form, to prevent someone from copying the material at a later stage in the rendering process in an unmarked form. In a video stream, for example, the watermark is preferably placed in the original full-frame encoding of the images, rather than in the compressed I, P, B frames. Otherwise, if the watermark is added to the 1, P, B frames, one could expand the I, P, B frames into full-frame encodings, then recreate corresponding I, P, B frames without the watermark. In like manner, watermarks are preferably added to the original digital encoding of audio information, rather than after data compression.

As illustrated in FIG. 1, the second component 200 includes a watermark detector 220 that detects a marking of the transformed content material from component 100, typically after some further transformation (such as I, P, B to full-frame encoding) by a transform module 210. The watermark detector 220 is configured to selectively control the transfer of the content material from the transform module 210 to the rendering device 300.

Note that conventional components that receive copy protected material from a source 101, such as disk drives, are typically configured to enforce copyright protection, but in so doing, such components are required to include sufficient capabilities to transform the content material to the form at which the copy protection mark can be detected (i.e., capabilities corresponding to transform module 210). By placing the watermark detector 220 at the component that includes the transform module 210, redundant functionality can be avoided. In addition it may be difficult to ascertain if a particular file on a hard drive contains content that may contain a watermark. A plethora of formats may exist, many of which may be unknown (or can be disguised) to the disk drive. However the rendering component has certain knowledge of the final form of the content.

However, a reason that conventional source-receiving components, such as disk drives, are configured to enforce copy protection, is because the copy protection scheme typically assures that the source 101 is an authorized source, based on information that is specific to the source 101. That is, the authentication of the source 101 requires information from the source 101 that is not available to the component 200, because it is not contained in the content material after it is transformed by module 110 of component 100, and thus the copy protection is conventionally performed at the component 100.

As illustrated in FIG. 1, the first component 100 includes a security module 120 that is configured to detect information from the source 101 that will serve to authenticate the source 101 as an authorized source of the content material. As noted above, a variety of techniques can be used to authenticate an authorized source, including, but not limited to, the use of data set identifiers and self referential sector identifiers, the use of physical identifiers on a disk, serial numbers, integrated circuits embedded in the disk, and so on.

In accordance with this invention, the first component 100 includes an encryption device 130 that is configured to provide a secure link to the second component 200 via a corresponding decryption device 230. The first component 100 transmits the authentication information from the module 120 to the second component 200 via this secure link 130-230. By communicating the authentication information from the first component 100 to the second component 200, the second component 200 is provided the information necessary to enforce copy protection via the detection module 220.

As detailed above, using conventional watermarking techniques, the watermark in the original baseband of the content material is an encoding of the authentication information that authenticates the source 101. The detection module 220 decodes the authentication information from the mark on the content material and compares it to the authentication information provided by the first component 100. If there is a correspondence between each of these versions of the authentication information, then the second component continues to provide the renderable content material to the rendering device 300. If the authentication information from the transformed content material does not correspond to the authentication information from the source of the content material, then the detection module 220 terminates the transmission of the renderable content material to the rendering device 300.

FIG. 2 illustrates an example flow diagram of the copy protection system of this invention, as executed in a component that controls the rendering of the material.

At 510, the material is received from a source component, such as a disk drive, and processed for rendering at 520. During or after this processing, the material is further processed to determine whether a security mark, such as a watermark, is present in the material, at 530. If no mark is found, the material is allowed to be rendered, at 580. If a mark is found, a secure link is established with the source component, at 540, and authentication information corresponding to the source of the content material is received and decrypted, at 550. The secure communication link is preferably established as a secure authenticated channel with unique session keys, using techniques common in the art. If the authentication information corresponds to the information contained in the watermark, the material is allowed to be rendered, at 580; otherwise, rendering is terminated, at 570.

One of ordinary skill in the art will recognize that the flow illustrated in FIG. 2 may be repeated if different authentication information is provided at different segments of the content material. For example, if each sector of a disk contains a different marking, then the different watermarks can be continuously detected in the content material and the different sector markings provided by the source component to effect a continuous authentication process. Alternatively, selected sectors can be verified, the selection being regular or random.

If multiple authentication information is provided, either as multiple copies of the same information, or different information, or a combination of both, the rendering of the content material may be based on multiple comparisons, so that, for example, rendering continues as long as a given percentage of comparisons are favorable. In this manner, the likelihood of an erroneous rejection of authorized material due to noise or other variations in the watermark can be reduced.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented in the context of providing authentication information from the source to be compared with encoded information in a watermark, the “correspondence” between the authentication information from the source and information from the watermark need not be based on a direct comparison of the information. The information contained in the watermark may merely indicate that the source of the material should be an “original”, and not a “copy”, and the information communicated from the source may merely indicate whether the source is a factory produced media or a user recorded media (i.e. whether the source is a “CD-ROM”, “CD-R”, “CD-R/W”, “DVD”, “DVD-RAM”, “DVD-R”; and so on). If the copy protection indicates that the source should be “original”, and the source component indicates that the material is being read from a “DVD-R”, then a correspondence does not exist, because material on a DVD-R is a “copy”, and not “original”. In this context, the first component 100 may merely be a disk-reader that reads the data from the disk and communicates this data to a second component 200 that processes the data, and also securely communicates the type of media to the second component 200. Additionally, the invention is presented in the context of independent components 100, 200, 300. One of ordinary skill in the art will recognize that the processing component 200 may be included within a rendering component 300. In like manner, although the information is presented in the context of avoiding the need for additional transformations in the first component 100, one of ordinary skill in the art will recognize that the principles of this invention can be employed even if the first component 100 is capable of deriving all of the information necessary to enforce copy protection within the first component 100. By also placing the copy protection component 200 at the front-end of a rendering device 300, the use of non-conforming source components 100 to provide unauthorized content material to a rendering device 300 can be prevented. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programing), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A system comprising:
a first component (100) that is configured to access a source (101) of content material in a first form, and transform the content material to a second form, and a second component (200), operably coupled to the first component (100), that is configured to receive the content material in the second form, and to detect a security mark from the content material,
the first component (100) is further configured to:
determine authentication information related to the mark, and
communicate the authentication information to the second component (200) via a secure link (130-230), and
the second component (200) is further configured to control rendering of the content material based on the mark and the authentication information.

2. The system of claim 1, wherein
the first component (100) includes a disk drive, and
the second component (200) includes a video processor.

3. The system of claim 1, wherein
the first component (100) includes a disk drive, and
the second component (200) includes a video display.

4. The system of claim 1, wherein
the security mark includes a watermark that includes an authorized authentication, and
the second component (200) is configured to control the rendering based on a comparison of the authorized authentication and the authentication information provided by the first component (100).

5. The system of claim 1, wherein
the second component (200) is further configured to establish a secure authenticated channel (130-230) with a unique session key with the first component (100), and
the first component (100) is configured to communicate the authentication information to the second component (200) via this secure authenticated channel (130-230).

6. The system of claim 1, wherein
the authentication information includes a hash value associated with the content material in the first form.

7. The system of claim 1, wherein
the authentication information includes a serial number associated with the source (101) of the content material.

8. The system of claim 1, wherein
the authentication information includes a type of media associated with the source. (101) of the content material.

9. The system of claim 1, wherein
the authentication information includes information from a circuit embedded in the media that is associated with the source (101) of the content material.

10. A method of protecting content material, comprising:
receiving the content material from a source (101) in a first component (100),
determining (120) authentication information related to the source (101) of the content material at the first component (100),
communicating the content material in the second form to a second component (200),
communicating (510) the authentication information to the second component (200) via a secure link (130-230),
determining (530) a security mark from the content material at the second component (200), and
controlling (560, 570, 580) a rendering of the content material from the second component (200) based on a correspondence (560) between the authentication information and the security mark.

11. The method of claim 10, wherein
receiving the content material includes reading data from a disk.

12. The method of claim 11, wherein
the rendering (580) of the content material includes displaying images corresponding to the content material.

13. The method of claim 10, wherein
the security mark includes a watermark.

14. The method of claim 10, wherein
the authentication information includes a media type comprising the source (101).

15. The method of claim 10, wherein
the authentication information includes a serial number associated with the source (101).

16. The method of claim 10, wherein
the authentication information includes a hash of a segment of the content material at the source (101).

17. The method of claim 10, further including
establishing a secure authenticated channel with a unique session key between the first component (100) and the second component (200), to create the secure link (130-230).

18. A component (100) comprising:
a first module (110) that is configured to:
receive content material from a source (101), and
communicate the content material in a transformed form to an other component (200),
a second module (120) that is configured to determine authentication information related to the source (101) of the content material, and
an encryption module (130) that is configured to encrypt the authentication information for communication to the other component (200).

19. The component (100) of claim 18, wherein
the source (101) is a disk, and
the first module (110) is further configured to read data from the disk.

20. The component (100) of claim 18, wherein
the content material includes video content, and
the other component (200) includes a display device (300).

21. The component (100) of claim 18, wherein
the encryption module (130) is further configured to create a unique session key with the other component (200) to encrypt the authentication information.

22. A component (200) comprising:
a first module (210) that is configured to:
receive content material from an other component (100) and
process the content material for rendering on a rendering device (300),
a second module (220) that is configured to detect a security mark associated with the content material, and
a decryption module (230) that is configured to:
receive encrypted information from the other component (100), and
decrypt the encrypted information to provide authentication information related to a source (101) of the content material,
wherein
the second module (220) is further configured to control the rendering of the content material based on a correspondence between the security mark and the authentication information.

23. The component (200) of claim 22, further including the rendering device (300).

24. The component (200) of claim 22, wherein
the rendering device (300) is a display.

25. The component (200) of claim 22, wherein
the source (101) includes a disk.

26. The component (200) of claim 22, wherein
the security mark includes a watermark.

27. The component (200) of claim 22, wherein
the decryption module (230) is further configured to create a unique session key with the other component (100) to decrypt the encrypted information.
